(19) United States
(12) Patent Application Publication
(10) Pub. No.: US 2016/0149299 A1
(43) Pub. Date: May 26, 2016

(54) MULTIBAND ANTENNA STRUCTURE

(71) Applicant: Skycross, Inc., San Jose, CA (US)

(72) Inventors: Chang Gyun Yoo, Gyeonggi-do (KR); Jin Su Kim, Gyeonggi-do (KR); Jae Nam Han, Gyeonggi-do (KR); Juno Lim, Gyeonggi-do (KR)

(21) Appl. No.: 14/568,801

(22) Filed: Dec. 12, 2014

(30) Foreign Application Priority Data
Nov. 25, 2014 (KR) 10-2014-0165046

(51) Int. Cl. H01Q 1/52

(52) U.S. Cl. CPC H01Q 1/521; H01Q 1/526

(57) ABSTRACT

The present disclosure relates to a multiband antenna structure which is capable of preventing interference between individual antennas in an antenna structure including a plurality of antennas having different shapes and bandwidths and maintaining a high level of isolation, although a distance between the antennas is reduced. A multiband antenna structure is capable of increasing a level of isolation by directly connecting an antenna connected to one feeding point and a ground coupling antenna (having a high frequency band) arranged adjacent to antenna connected to the feeding point.

### CROSS-REFERENCE TO RELATED APPLICATION

The present application claims the benefit of priority to Korean Patent Application No. 10-2014-0165046 filed on Nov. 25, 2014, which is hereby incorporated herein by reference in its entirety.

### FIELD OF THE DISCLOSURE

The present disclosure relates to a multiband antenna structure and more particularly, to a multiband antenna structure which is capable of preventing interference between individual antennas in an antenna structure including a plurality of antennas having different shapes and bandwidths and maintaining a high level of isolation, although a distance between the antennas is reduced.

### BACKGROUND

With rapid spread of mobile communication systems and wireless data communication systems and coexistence of different established radio broadcastings and radio technologies, there is a recent fast-growing demand for a radio capable of being operated on a variety of frequency bands. In addition, there is also a fast-growing need of the radio to decrease in its size for portability.

In particular, with upsurge of interest in digital convergence, tastes of users who wish to purchase a single product to meet their different desires have been generalized. In addition, needs for availability of vast resources and guarantee of communication connectivity using basic communication in any mobile devices have also been generalized. This has something in common with a trend directing to ubiquitous environments to allow any devices to make network access anytime and anywhere.

In addition, wideband wireless communication systems such as WiMax, 802.11x or LTE, appearing as the next generation communication systems, use multidimensional signals of MIMO (Multiple-Input Multiple-Output) using a plurality of antennas to improve both of bandwidth and confidence, smart antennas using a plurality of antennas to adjust desired communication environments, etc., in order to reduce a difference between wired communication and wireless communication.

Since these next generation wideband wireless communication systems use a plurality of antennas, a space occupied by these antennas increases and antenna design and arrangement are becoming more difficult as additional antennas for multiband support by combination of various communication systems are needed.

Such combinational antenna arrangement generates interference between antennas. Therefore, as the antennas become closer to each other, it is difficult to meet desired antenna performance due to problems caused by coupling.

### BRIEF DESCRIPTION OF THE DRAWINGS

The above and/or other aspects and advantages of the present disclosure will become apparent and more readily appreciated from the following description of the embodiments, taken in conjunction with the accompanying drawings of which:

FIG. 1 shows a pair of dipole antennas arranged adjacent to each other.

FIG. 2 is a conceptual view for explaining a state of operation of the pair of dipole antennas arranged adjacent to each other.

FIG. 3 is a characteristic view showing a characteristic of the antenna operation shown in FIG. 1.

FIG. 4 shows a multiband antenna structure employing a scheme of directly interconnecting power feeding points.

FIG. 5 shows a multiband antenna structure according to an embodiment of the present disclosure.

### DETAILED DESCRIPTION

References are made to particular embodiments with reference to the accompanying drawings so that those skilled in the art can easily practice the particular embodiments. It is to be understood that a variety of embodiments of the present disclosure are different but are not mutually exclusive. For example, particular features, structure and characteristics set forth herein may be implemented by different embodiments in connection with an embodiment disclosed herein, without departing from the spirit and scope of the disclosure. In addition, it is to be understood that positions and arrangements of individual elements of the embodiment disclosed herein may be changed without departing from the spirit and scope of the disclosure. Accordingly, embodiments described in the specification and elements shown in the drawings are illustrative only and do not cover all of the technical ideas of the present disclosure. It should be, therefore, understood that the scope of the disclosure is defined by only the claims and their equivalents, if stated appropriately. Throughout the drawings, the same or similar elements are denoted by the same reference numerals.

Hereinafter, embodiments of the present disclosure will be described in detail with reference to the drawings.

To overcome limitations in the art, it is an object of the present disclosure to provide a multiband antenna structure which is capable of increasing a level of isolation by directly connecting an antenna connected to one feeding point and a ground coupling antenna (having a high frequency band) arranged adjacent to antenna connected to the feeding point, instead of directly electrically interconnecting the antennas respectively connected to the pair of feeding points.

To achieve the above object, according to an embodiment of the disclosure, there is provided a multiband antenna structure including: a pair of feeding points; a pair of antennas which are equal or not to each other and are respectively connected to the feeding points; a coupling antenna which is arranged adjacent to one antenna in the form of ground coupling and corresponds to the highest frequency band of the antennas; and a connection line connecting between the other antenna and the coupling antenna so that an induced current can make a detour and be cancelled.

According to one aspect, the multiband antenna structure of the present disclosure has an advantage in that it is capable of increasing a level of isolation by directly connecting an antenna connected to one feeding point and a ground coupling antenna (having a high frequency band) arranged adjacent to antenna connected to the feeding point.

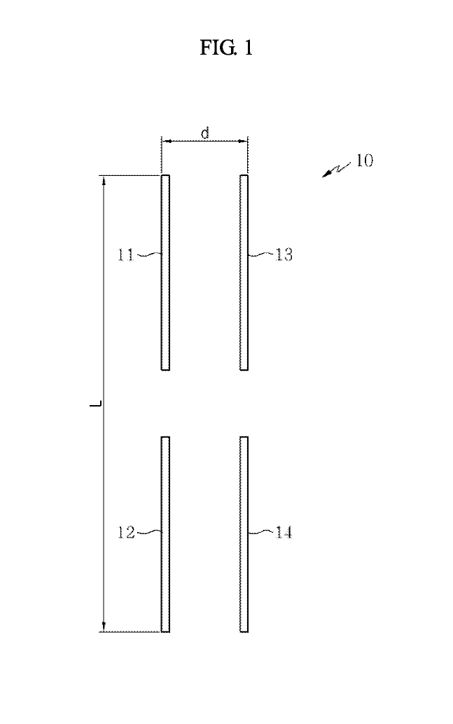

FIG. 1 shows an example of an antenna structure 10 constituted by a pair of dipole antennas. As shown, the antenna structure 10 includes the pair of dipole antennas 11/12 and 13/14 arranged in parallel, i.e., the first dipole antenna 11/12 and the second dipole antenna 13/14, with their length denoted by L and an isolation distance therebetween denoted by d, with no elements connected therebetween. The length L of each of the first and second dipole antennas shows a reference resonance frequency in close correspondence to a ½ wavelength and each antenna is connected to a separate transceiver system and can be operated at the same frequency.

In this pair of dipole antennas, an induced current based on operation of a neighboring dipole antenna is differently generated depending on the isolation distance d. Such coupling sharply increases with decrease of the isolation distance d.

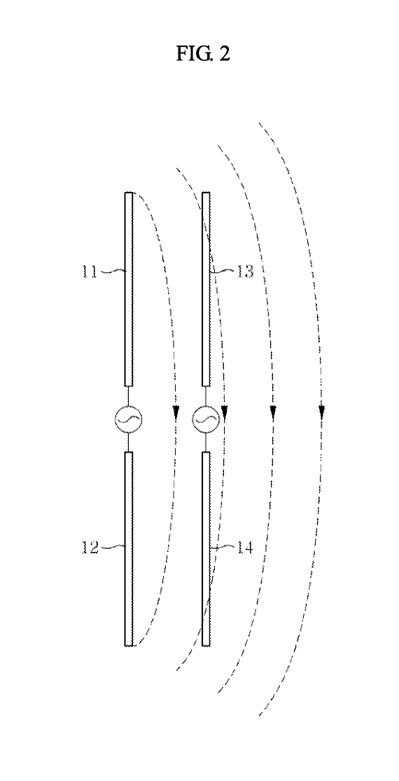

FIG. 2 is a conceptual view of coupling that shows the existence of a current induced in the second dipole antenna 13/14 based on the operation of the first dipole antenna 11/12. A current caused by parasitic excitation of dipole is excited from a neighboring dipole passing through source impedance, which results in mutual coupling between ports. If such coupling cannot be decreased in magnitude or cannot be completely electrically isolated, this may have an adverse effect on the system, such as causing saturation and desensitization of a receiver connected to a neighboring antenna or degradation of a transmitter connected to a neighboring antenna. In addition, currents appearing between neighboring antennas distort gain patterns produced from individual dipoles, which also may have an adverse effect on the system.

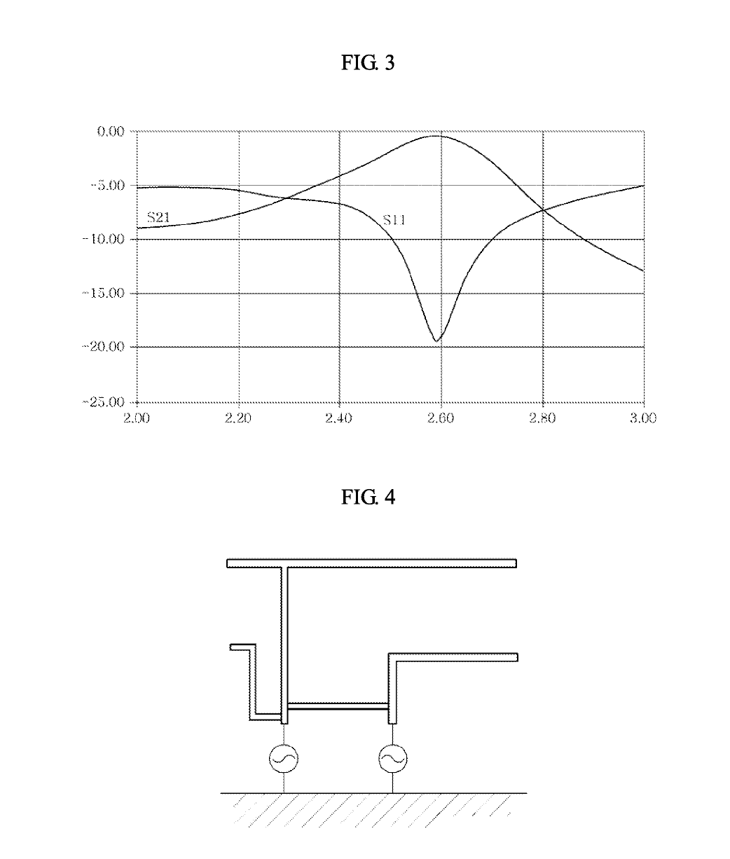

FIG. 3 shows characteristics, such as scattering parameters S11 and S12, between the pair of dipole antennas arranged adjacent to each other as shown in FIG. 1. The S12 curve representing an isolation characteristic by a neighboring antenna shows a minimal gain, that is, severe mutual interference, at an antenna use band. Since an isolation characteristic of a commercial antenna has generally to be at least −5 dB or less, preferably at about −10 dB which is required to be admitted to provide effective performance. Therefore, the pair of dipole antenna representing the shown characteristics cannot be put in practical use.

In other words, in this case, if the isolation distance between the pair of dipole antennas is not increased, this means that the antennas cannot be normally operated.

To overcome this, the antennas have to be separated from each other in order to prevent a distortion due to a coupling which is produced when the antennas are arranged in proximity to each other for compactness of the antennas, which results in increase in antenna size and restriction on an antenna design for small-sized communication devices requiring a built-in antenna.

On the other hand, there are fast-growing cases to require communications for additional bands in addition to the antennas for supporting the multiband antenna communication system. These cases require an additional isolated antenna structure for prevention of coupling, which results in increase in a space required for the antenna structure and difficulty in implementation of a built-in antenna.

Further, as shown in FIG. 4, there is a case in which different antennas having different power feeds are directly interconnected to increase a level of isolation. However, this case provides a low level of isolation and hence a narrow practical use band.

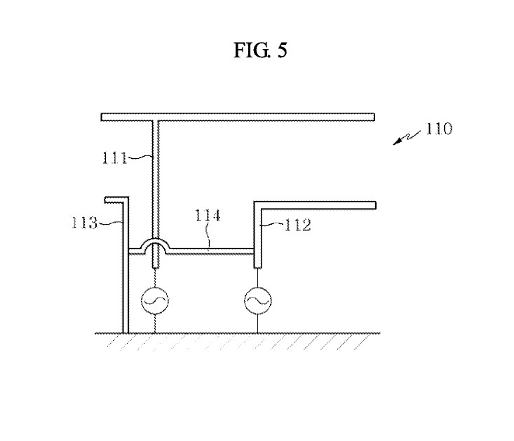

FIG. 5 shows a multiband antenna structure according to an embodiment of the present disclosure.

Referring to FIG. 5, a multiband antenna structure 110 of the present disclosure includes a pair of feeding points, a pair of antennas 111 and 112 which may be equal or not to each other and are respectively connected to the feeding points, a coupling antenna 113 which is arranged adjacent to one antenna 111 in the form of ground coupling and corresponds to the highest frequency band of the antennas, and a connection line 114 connecting between the other antenna 112 and the coupling antenna 113 so that an induced current can make a detour and be cancelled.

The size of current between the other antenna 112 detoured via the shown connection line 114 and the one antenna 111 coupled by the coupling antenna 113 is made similar on an antenna-basis, which results in cancellation of the detouring current and maintenance of s level of isolation. Therefore, since the level of isolation is even higher than that in the multiband antenna structure employing the scheme of directly interconnecting power feeding points as shown in FIG. 4, a use bandwidth can be extended.

While the present disclosure has been particularly shown and described with reference to exemplary embodiments thereof, it will be understood by those skilled in the art that various changes in form and details may be made therein without departing from the spirit and scope of the present disclosure. The exemplary embodiments are provided for the purpose of illustrating the disclosure, not in a limitative sense. Thus, it is intended that the present disclosure covers the modifications and variations of this disclosure provided they come within the scope of the appended claims and their equivalents.

What is claimed is:

1. A multiband antenna structure, comprising:
a pair of feed points;
a pair of antennas respectively connected to the pair of feed points;
a coupling antenna which is arranged adjacent to one of the pair antennas; and
one or more connection lines connecting between one of the pair of antennas and the coupling antenna so that an induced current can make a detour.

2. The multiband antenna structure of claim 1, wherein the induced current bypasses one of the pair of feed points.

3. The multiband antenna structure of claim 1, wherein a portion of the induced current is cancelled.

4. The multiband antenna structure of claim 1, wherein the coupling antenna is arranged adjacent to the one of the pair of antennas in a form of a ground coupling.

5. The multiband antenna structure of claim 1, wherein the coupling antenna has a higher frequency band than each of the pair of antennas.

6. The multiband antenna structure of claim 1, wherein the coupling antenna has a higher frequency band than one of the pair of antennas.

7. The multiband antenna structure of claim 1, wherein the pair of antennas are similar in structure.

8. The multiband antenna structure of claim 1, wherein the induced current bypasses one of the pair of feed points such that a first antenna mode excited on one of the pair of antennas is at least partially isolated from a second antenna mode of the pair of antennas.

9. The multiband antenna structure of claim 8, wherein the multiband antenna structure does not utilize a decoupling network between the pair of feed points to at least partially isolate the first antenna mode from the second antenna mode.

10. The multiband antenna structure of claim 1, wherein the multiband antenna structure generates diverse antenna patterns.

11. An antenna structure, comprising:
a pair of feed points;
a pair of antennas coupled to the pair of feed points;
a coupling antenna which is arranged adjacent to one of the pair antennas; and
one or more coupling lines electrically connecting between one of the pair of antennas and the coupling antenna so that a first antenna mode excited on one of the pair of antennas is at least partially isolated from a second antenna mode of the pair of antennas.

12. The antenna structure of claim 11, wherein an induced current on one of the pair of antennas bypasses one of the pair of feed points.

13. The antenna structure of claim 12, wherein a portion of the induced current is cancelled.

14. The antenna structure of claim 11, wherein the coupling antenna is coupled to ground.

15. The antenna structure of claim 11, wherein the coupling antenna has a higher frequency band than one of the pair of antennas.

16. The antenna structure of claim 11, wherein the pair of antennas are similar in structure.

17. The antenna structure of claim 11, wherein the antenna structure does not utilize a decoupling network between the pair of feed points to at least partially isolate the first antenna mode from the second antenna mode.

18. A communication device, comprising:
an antenna structure comprising:
a pair of feed points;
a pair of antennas coupled to the pair of feed points;
a coupling antenna which is arranged adjacent to one of the pair antennas; and
one or more coupling lines electrically coupling between one of the pair of antennas and the coupling antenna so that the antenna structure generates diverse antenna patterns;
a transceiver coupled to the antenna structure for receiving and transmitting wireless signals;
a memory that stores instructions; and
a processor that controls operations of the communication device.

19. The communication device of claim 18, wherein the one or more coupling lines cause a first antenna mode excited on one of the pair of antennas to be at least partially isolated from a second antenna mode of the pair of antennas.

20. The communication device of claim 18, wherein the antenna structure generates diverse antenna patterns.
